(19) United States
(12) Patent Application Publication
(10) Pub. No.: US 2008/0093975 A1
(43) Pub. Date: Apr. 24, 2008

(54) LIGHT EMISSION DEVICE AND DISPLAY DEVICE

(76) Inventors: Kyung-Sun Ryu, Yongin-si (KR); Yong-Gun Won, Yongin-si (KR)

Correspondence Address: CHRISTIE, PARKER & HALE, LLP, PO BOX 7068, PASADENA, CA, 91109-7068, US

(21) Appl. No.: 11/738,904

(22) Filed: Apr. 23, 2007

(30) Foreign Application Priority Data
Oct. 23, 2006 (KR) 10-2006-0102907

(51) Int. Cl. H01J 1/62

(52) U.S. Cl. 313/496

(57) ABSTRACT

A light emission device and a display device provided with the light emission device. The light emission device includes first and second substrates opposing each other; a side member located between periphery regions of the first and second substrates to define a vacuum chamber with the first and second substrates; an electron emission unit disposed on the first substrate; and a light emission unit disposed on the second substrate and adapted to emit light using electrons emitted from the electron emission unit. The light emission unit includes a phosphor layer and an anode electrode disposed on a surface of the phosphor layer, and the anode electrode is applied with a voltage through an anode terminal penetrating through the side member.

### CROSS-REFERENCE TO RELATED APPLICATION

This application claims priority to and the benefit of Korean Patent Application No. 10-2006-0102907, filed on Oct. 23, 2006, in the Korean Intellectual Property Office, the entire content of which is incorporated herein by reference.

### BACKGROUND OF THE INVENTION

1. Field of the Invention

The present invention relates to a light emission device and a display using the light emission device as a light source.

2. Description of Related Art

A liquid crystal display is an example of a passive type display device (or non-self-emissive display device) requiring a light source. The liquid crystal display includes a display panel having a liquid crystal layer and a polarizer plate and a light emission device for emitting light toward the display panel. The display panel receives the light from the light emission device and selectively transmits or blocks the light using the liquid crystal layer and the polarizing plate, thereby displaying an image.

Recently, in a passive type display device, a light emission device that is a surface (or area) light source using a cold cathode electron emission source has been proposed to replace a cold cathode fluorescent lamp (CCFL) that is a line light source and/or a light emitting diode (LED) that is a point light source.

A light emission device using the cold cathode electron emission source includes an anode electrode for accelerating electrons. The anode electrode is applied with a high voltage ranging from hundreds to thousands of volts through an anode terminal. The anode terminal is generally located on a surface of a substrate of the light emission device and extends out of a vacuum vessel (or chamber) through a gap between the substrate and a side member.

In the above-described anode voltage applying structure, since the anode terminal is located on the surface of the substrate, the substrate should be provided at an outer portion of the side member with an additional extension portion where the anode terminal is located. Therefore, the anode voltage applying structure of the above-described light emission device has a drawback because it increases a dead space of the substrate.

### SUMMARY OF THE INVENTION

An aspect of an embodiment of the present invention is directed to an anode terminal for applying a voltage to an anode electrode

Aspects of exemplary embodiments of the present invention are directed to a light emission device that can avoid damage to a substrate while also reducing (or minimizing) a dead space (e.g., an inactive region of the light emission device).

Aspects of exemplary embodiments of the present invention are directed to a light emission device that has a light emission surface divided into a plurality of regions and that can independently control a light emission intensity of each divided region, and a display device that can enhance a dynamic contrast by employing the light emission device.

In an exemplary embodiment of the present invention, a light emission device includes first and second substrates opposing each other; a side member located between periphery regions of the first and second substrates to define a vacuum chamber with the first and second substrates; an electron emission unit disposed on the first substrate; and a light emission unit disposed on the second substrate and adapted to emit light using electrons emitted from the electron emission unit. Here, the light emission unit includes a phosphor layer and an anode electrode disposed on a surface of the phosphor layer, and the anode electrode is applied with a voltage through an anode terminal penetrating through the side member.

In addition, the side member may be provided with a through hole through which the anode terminal penetrates, and the anode terminal may include a lead portion inserted and fixed in the through hole and a wire portion extending from the lead portion and contacting the anode electrode. The wire portion may be formed of a material having an elastic property.

Also, the lead portion may be arranged to be substantially in parallel with the first and second substrates, and the wire portion may be bent toward the anode electrode by an angle, which may be predetermined. In addition, a distal end of the wire portion, which contacts the anode electrode, may be rounded toward the first substrate.

In addition, a sealing member may be interposed between the side member and the anode terminal.

A distance between the first and second substrates may be in a range from about 5 mm to about 20 mm.

In another exemplary embodiment of the present invention, a display device includes the above-described light emission device and a display panel for displaying an image by receiving light from the light emission device. Here, the display panel may be a liquid crystal panel.

In addition, the display panel may include first pixels and the light emission device may include second pixels, the second pixels being less in number than the first pixels and intensities of light emitted from the second pixels being independently controlled.

### BRIEF DESCRIPTION OF THE DRAWINGS

FIG. 1 is a partial sectional view of a light emission device according to an exemplary embodiment of the present invention.

FIG. 2 is a partial perspective view of a side member and an anode terminal of the light emission device of FIG. 1.

FIG. 3 is a partially exploded perspective view of the light emission device of FIG. 1.

FIG. 4 is an exploded perspective view of a display device according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Also, in the context of the present application, when an element is referred to as being “on” another element, it can be directly on the another element or be indirectly on the another element with one or more intervening elements interposed therebetween. Like reference numerals designate like elements throughout the specification.

A light emission device of certain exemplary embodiments can be construed as a light source of a display device (e.g., a non-self-emissive display device such as a liquid crystal display, etc.) or a display device for displaying an image (e.g., a self-emissive display device for displaying an image).

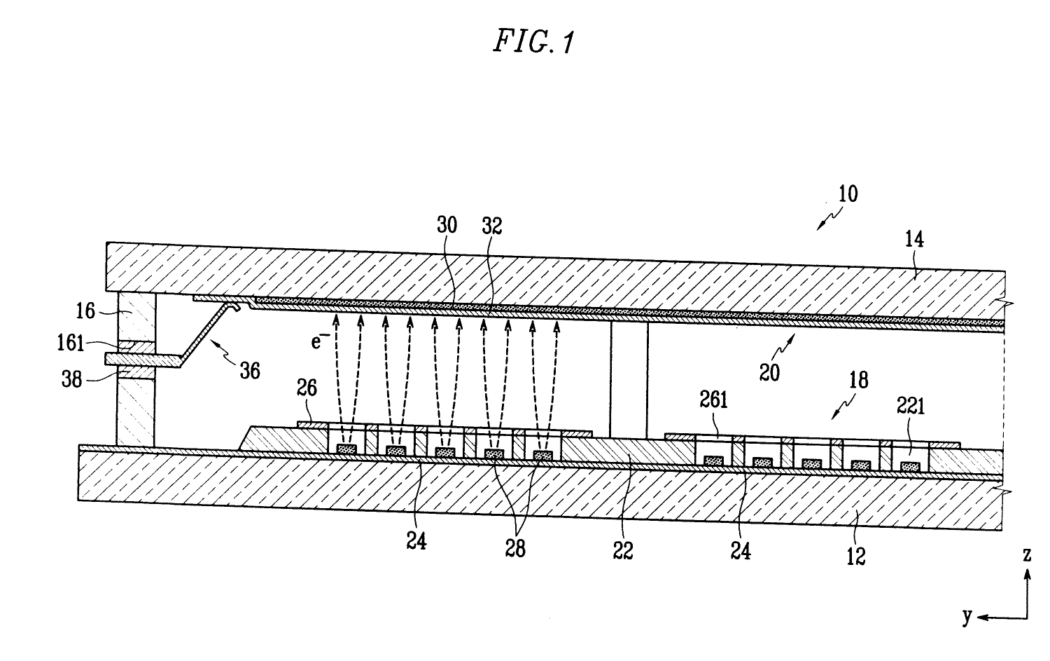

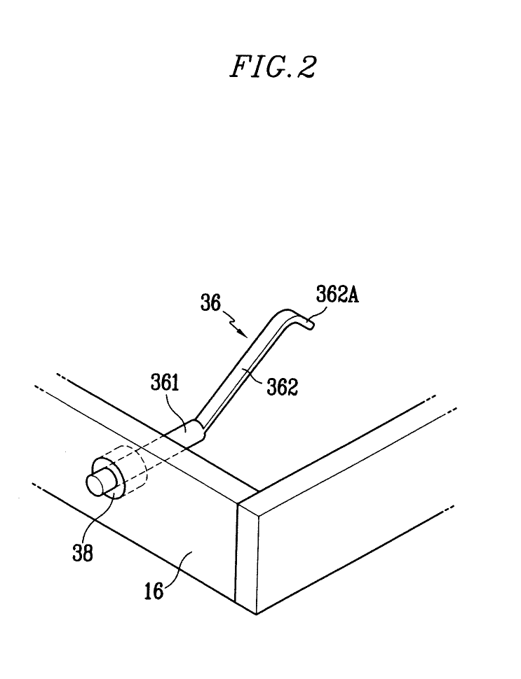

FIG. 1 is a partial sectional view of a light emission device according to an exemplary embodiment of the present invention and FIG. 2 is a partial perspective view of a side member and an anode terminal of the light emission device of FIG. 1.

Referring to FIG. 1, a light emission device 10 according to an exemplary embodiment of the present invention includes first and second substrates 12 and 14 opposing (or facing) each other in parallel with a distance therebetween (wherein the distance may be predetermined). A side member 16 is provided between peripheries (or periphery regions) of the first and second substrates 12 and 14 to seal the first and second substrates 12 and 14 together to thus form a vacuum vessel (or vacuum chamber). The interior of the vacuum vessel is exhausted and kept to a degree of vacuum of about 10⁻⁶ Torr.

Each of the first and second substrates 12 and 14 is divided into an active region substantially for emitting visible light (e.g., for emitting light inside the vacuum vessel formed by the side member 16 and the first and second substrates 12 and 14) and an inactive region surrounding the active region. An electron emission unit 18 for emitting electrons is provided at the active region of the first substrate 12 and a light emission unit 20 for emitting the visible light is provided at the active region of the second substrate 14.

The electron emission unit 18 includes first and second electrodes 24 and 26 that are arranged with an insulation layer 22 interposed therebetween, and electron emission regions 28. The light emission unit 20 includes a phosphor layer 30 and an anode electrode 32. The light emission unit 18 and the light emission unit 200 will be described in more detail below.

In addition, the anode electrode 32 is applied with an anode voltage through an anode terminal 36 penetrating through the side member 16. That is, the anode terminal 36 penetrates through the side member 16 to directly contact the anode electrode 32. Here, the side member 16 is provided with a through hole 161 and a sealing member 38 is located between the side member 16 and the anode terminal 36.

In more detail and with reference to FIG. 2, the anode terminal 36 includes a lead portion 361 that is partially (or partly) inserted and fixed in the through hole 161 of the side member 16 and a wire portion 362 that extends from the lead portion 361 toward a side of the vacuum vessel and directly contacts the anode electrode 32.

Since the lead portion 361 is fixed in the through hole 161 of the side member 16, it is arranged to be substantially in parallel with the first and second substrates 12 and 14.

In order to contact the anode electrode, the wire portion 362 is bent toward the anode electrode 32 by an angle (which may be predetermined). An extreme end (or distal end) 362A of the wire portion 362 is rounded downward (e.g., first bend toward the second substrate 14 and then toward the first substrate 14) so as to prevent (or protect) the anode electrode 32 from being damaged when it contacts the anode electrode 32.

The anode terminal 36 is formed of a conductive material that can apply a voltage to the anode electrode 32. In addition, the wire portion 362 may be formed of a material having an relative high elasticity (which may be predetermined), for example, the wire portion 362 may be formed of a metal, such as chrome or alloy thereof, so that it can easily pass through the through hole 161 of the side member 16 and obtain a sufficient contact force with the anode electrode 32.

In one embodiment, because of its relative high elasticity, even when the wire portion 362 is deformed while passing through the through hole 161, it can be restored to its initial shape by an elastic restoration force and the contacting of the wire portion 362 with the anode electrode 32 can be reliably realized.

In addition, a sealing member located between the side member 16 and the lead portion 361 may be formed of a glass material, such as frit.

In FIG. 1, a case where the through hole 161 and the lead portion 361 have circular sections is illustrated for exemplary purposes, and the present invention is not limited to this case. The sections (or cross sections) of the through hole 161 and the lead portion 361 may be formed in any suitable polygonal shapes. In addition, although the wire portion 362 is shown to have a straight longitudinal section, the present invention is not limited to this configuration. That is, the straight longitudinal section of the wire portion 362 may be suitably varied to have, for example, a curved longitudinal section as long as it can reliably contact the anode electrode 32.

By contrast, in one embodiment, if the anode terminal 36 is formed to penetrate one of the first and second substrates 12 and 14 rather than to penetrate the side member 16, the penetrated (or relevant) substrate may be damaged. That is, due to a vacuum force of the vacuum vessel, a compression force is applied in a vertical direction between the first and second substrates 12 and 14. Therefore, if the through hole for the insertion of the anode terminal 36 is formed in one of the first and second substrates 12 and 14, a portion around the through hole is weakened (or the compression formed is concentrated at the portion around the through hole), thereby causing cracks around the through hole. Since the side member 16 has structurally a higher supporting force against the compression force, the chance of a damage to the side member when being provided with the through hole is lower than that of the substrate.

Furthermore, when the through hole is formed in one of the first and second substrates 12 and 14, it becomes difficult to perform thin film deposition and patterning processes on the relevant substrate.

Also, in one embodiment, the anode terminal 36 is inserted through the through hole 161 of the side member 16 before the first and second substrates 12 and 14 are sealed together. In another embodiment, the anode terminal 36 is inserted through the through hole 161 of the side member 16 after the first and second substrates 12 and 14 are sealed together. In yet another embodiment, the anode terminal 36 is inserted through the through hole 161 of the side member 16 at about the same time the first and second substrates 12 and 14 are sealed together.

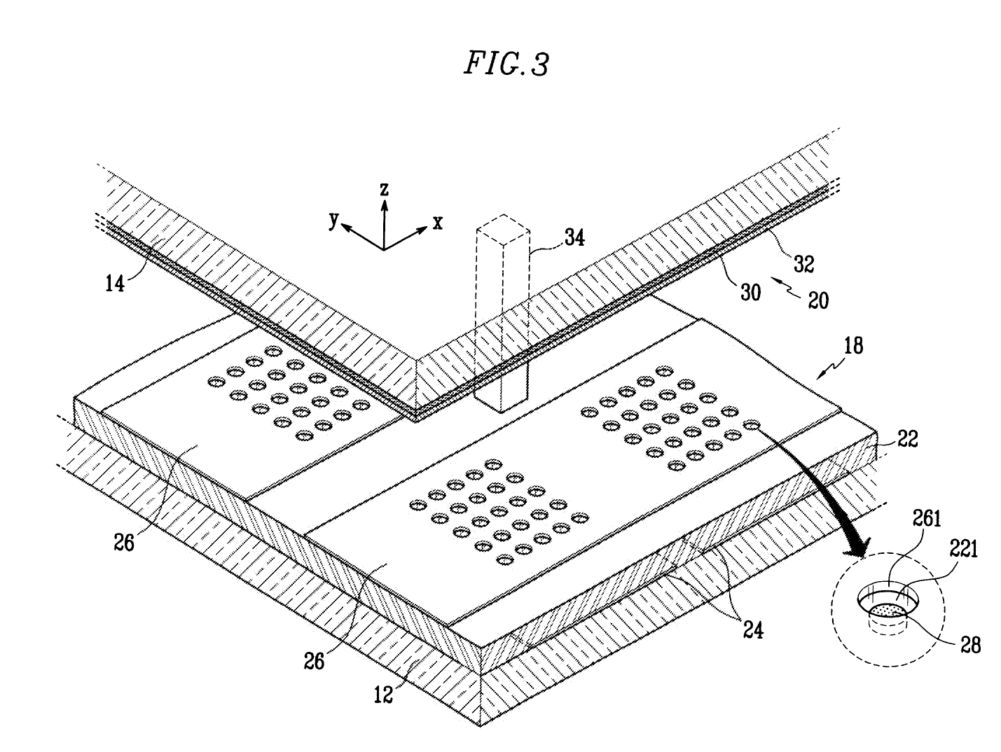

FIG. 3 is a partially exploded perspective view of the light emission device, illustrating detailed structures of the electron emission unit 18 and the light emission unit 20.

The electron emission unit 18 may include Field Emitter Array (FEA) electron emission elements, Surface Conduction Emitter (SCE) electron emission elements, Metal-Insulator-Metal (MIM) electron emission elements, and/or Metal-Insulator-Semiconductor (MIS) electron emission elements. In FIG. 3, the electron emission unit 18 is illustrated to have the FEA electron emission elements.

Referring to FIG. 3, the electron emission unit 18 includes the first electrodes 24 arranged in a stripe pattern extending in a first direction and the second electrodes 26 arranged in a stripe pattern extending in a second direction crossing (or intersecting) the first direction of the first electrodes 24. The insulation layer 22 is interposed between the first electrodes 24 and the second electrodes 26. The electron emission unit 18 further includes electron emission regions 28 electrically connected to the first electrodes 24 or the second electrodes 26.

When the electron emission regions 28 are formed on the first electrodes 24, the first electrodes 24 function as cathode electrodes for applying a current to the electron emission regions 28 and the second electrodes 26 function as gate electrodes for inducing the electron emission by forming an electric field using a voltage difference from the cathode electrodes. By contrast, when the electron emission regions 28 are formed on the second electrodes 26, the second electrodes 26 function as the cathode electrodes and the first electrodes 24 become the gate electrodes.

In one embodiment, among the first and second electrodes 24 and 26, the electrodes extending in a row direction (e.g., an x-axis in FIG. 3) of the light emission device 10 function as the scan electrodes, and the electrodes extending in a column direction (e.g., a y-axis in FIG. 3) function as data electrodes.

In FIG. 3, a case where the electron emission regions 28 are formed on the first electrodes 24, the first electrodes 24 are arranged in the row direction of the light emission device 10, and the second electrodes 26 are arranged in the column direction of the light emission device 10 is illustrated as an example. However, the locations of the electron emission regions 28 and the arrangement of the first and second electrodes 24 and 26 are not limited to the above case and can be suitably varied (or changed).

Openings 261 and openings 221 are respectively formed in the second electrodes 26 and the insulation layer 22 to partially (or partly) expose the surface of the first electrodes 24. Electron emission regions 28 are located on the first electrodes 24 in the openings 221 of the insulation layer 22 and/or in the openings 261 of the second electrodes 26.

The electron emission regions 28 are formed of a material for emitting electrons when an electric field is applied thereto under a vacuum atmosphere, such as a carbon-based material or a nanometer-sized material.

For example, the electron emission regions 28 can be formed of carbon nanotubes, graphite, graphite nanofibers, diamonds, diamond-like carbon, fullerene C₆₀, silicon nanowires or combinations thereof. The electron emission regions 28 may be formed through a screen-printing process, a direct growth process, and/or chemical deposition.

Considering an electron beam diffusion property, in one embodiment, the electron emission regions 28 are gathered at a central portion of each crossing (or intersecting) region of the first and second electrodes 24 and 26 rather than at a periphery of each crossing (or intersecting) portion.

Each crossing (or intersecting) region of the first and second electrodes 24 and 26 may correspond to one pixel region of the light emission device 10. Alternatively, two or more crossing (or intersecting) regions of the first and second electrodes 24 and 26 may correspond to one pixel region of the light emission device 10. In this case, two or more first electrodes 24 and/or two or more second electrodes 26 that are placed at a common pixel region are electrically connected to each other to be applied with a common driving voltage.

The light emission unit 20 includes the phosphor layer 30 and the anode electrode 32 formed on a surface of the phosphor layer 30. The phosphor layer 30 may be formed of a white phosphor layer or of a combination of red, green and blue phosphors, which can emit white light. In FIG. 3, the former is illustrated as an example.

When the phosphor layer 30 is formed of the white phosphor layer, the phosphor layer may be formed on an entire surface of the second substrate 14 or patterned to have a plurality of sections corresponding to the respective pixels.

When the light emission device 10 is designed to be used as an imaging display, the phosphor layer 30 is formed with a combination of the red, green and blue phosphor layers. In this case, the red, green and blue phosphor layers are formed in each pixel region with a pattern that may be predetermined. A black layer may be formed between the red, green, and blue phosphor layers.

The anode electrode 32 may be formed of a metal layer such as an aluminum (Al) layer covering the phosphor layer 30. The anode electrode 32 is an acceleration electrode that receives a high voltage to maintain the phosphor layer 30 at a high electric potential state. Here, the anode electrode 32 can also function to enhance the luminance of the active region by reflecting the visible light, which is emitted from the phosphor layer 30 to the first substrate 12, back toward the second substrate 14.

Located between the first and second substrates 12 and 14 are spacers 34 that are able to withstand a compression force applied to the vacuum vessel of the light emission device 10 and to uniformly maintain a gap between the first and second substrates 12 and 14.

The above-described light emission device 10 is driven by applying external driving voltages to the first electrodes 24 and the second electrodes 26 and by applying a positive direct current voltage, e.g., at thousand of volts, to the anode electrode 32.

Electric fields are formed around the electron emission regions 28 at the pixels where the voltage difference between the first and second electrodes 24 and 26 is equal to or greater than the threshold value, and thus electrons are emitted from the electron emission regions 28. The emitted electrons collide with a corresponding portion of the phosphor layer 30 of the relevant pixels by being attracted to the high voltage applied to the anode electrode 32, thereby exciting the phosphor layer 30. A light emission intensity of the phosphor layer of each pixel corresponds to a light emission amount of the corresponding pixel.

When the above-described light emission device 10 is used as a light source of a display device, it can realize a luminance of 10,000 cd/m² at a central portion of the active region. The anode electrode 32 may be applied with a voltage of 10 kV or more, and, in one embodiment, the anode electrode 32 is applied with a voltage ranging from 10 to 15 kV. Therefore, the first and second substrates 12 and 14 are spaced apart from each other by a relatively large distance of about 5 to 20 mm to avoid an electrical instability such as a short circuit in the vacuum vessel due to the high voltage applied to the anode electrode 32.

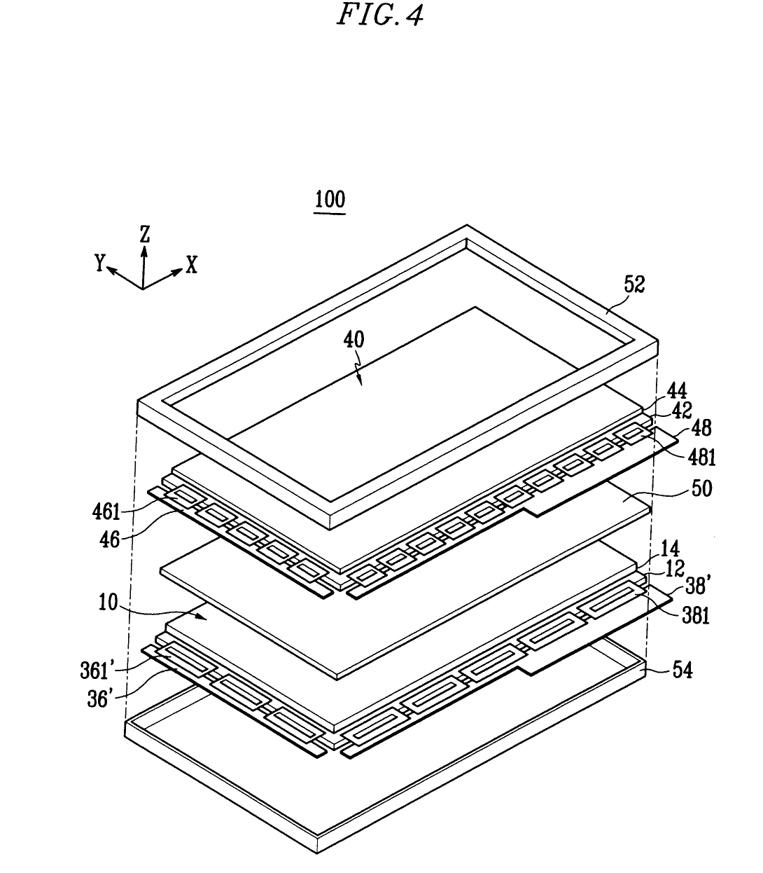

FIG. 4 is an exploded perspective view of a display device according to an embodiment of the present invention. The display device illustrated in FIG. 4 is only provided as an example, and the present invention is not thereby limited.

Referring to FIG. 4, a display device 100 includes a display panel 40 located in front of (or on) the light emission device 10. A diffuser plate 50 for uniformly diffusing light emitted from the light emission device 10 to the display panel 40 may be located between the light emission device 10 and the display panel 40. The diffuser plate 50 is spaced apart from the light emission device 10 by a distance therebetween that may be predetermined. A top chassis 52 is located in front of (or on) the display panel 40, and a bottom chassis 54 is located in rear of (or behind) the light emission device 10.

A liquid crystal panel or other suitable non-self-emissive type (or passive-type) display panels may be used as the display panel 40. In the following description, a case where the display panel 40 is the liquid crystal panel will be provided as an example in more detail.

The display panel 40 includes a thin film transistor (TFT) panel 42 having a plurality of TFTs, a color filter panel 44 located above (or on) the TFT panel 42, and a liquid crystal layer formed between the panels 42 and 44. One or more polarizing plates are attached on the color filter panel 44 and the TFT panel 42 to polarize the light passing through the display panel 40.

The TFT panel 42 is a transparent glass substrate on which the TFTs are arranged in a matrix pattern. Each of the TFTs has source terminals connected to data lines, gate terminals connected to gate lines, and a drain terminal on which pixel electrodes formed of a transparent conductive material are formed.

When an electric signal is input from first printed circuit boards 46 and 48 to the respective gate and data lines, the electric signal is input to the gate and source terminals of the TFT and the TFT is turned on or off in accordance with the electric signal to output an electric signal required for forming a pixel to the drain terminal.

The color filter panel 44 is a panel on which RGB pixels that are color pixels for emitting colors when the light passes therethrough are formed through a thin film process. A common electrode formed of a transparent conductive material is formed on an entire surface of the color filter panel 44.

When the TFT is turned on by applying electric power to the gate and source terminals, an electric filed is formed between the pixel electrode and the common electrode of the color filter panel 44. A twisting angle of liquid crystal molecular alignment and/or orientation between the TFT panel 42 and the color filter 44 is varied, in accordance of which, the light transmittance of the corresponding pixel is varied.

The first printed circuit boards 46 and 48 of the display panel 40 are respectively connected to driving IC packages 461 and 481. In order to drive the display panel 40, the gate printed circuit board 46 transmits a gate driving signal, and the data printed circuit board 48 transmits a driving signal (or data driving signal).

The light emission device 10 includes a plurality of pixels, the number of which is less than the number of pixels of the display panel 40 so that one pixel of the light emission device 10 corresponds to two or more pixels of the display panel 52. Each pixel of the light emission device 10 emits the light in response to a highest gray level among gray levels of the corresponding pixels of the display panel 40. The light emission device 10 can represent a gray level ranging from 2 to 8 bits at each pixel.

For convenience purposes, the pixels of the display panels 40 are referred as first pixels and the pixels of the light emission device 10 are referred as second pixels. The two or more first pixels that correspond to one second pixel are referred as a first pixel group.

Describing a driving process of the light emission device 10, a signal control unit for controlling the display panel 40 detects the highest gray level of the first pixel group, operates a gray level required for emitting light from the second pixel in response to the detected highest gray level, converts the operated gray level into digital data, and generates a driving signal of the light emission device 10 using the digital data. The driving signal of the light emission device 10 includes a gate driving signal and a data driving signal.

Second printed circuit boards 36′ and 38′ of the light emission device 10 are connected to driving IC packages 361′ and 381. In order to drive the light emission device 10, the scan printed circuit board 36′ transmits the scan driving signal, and the data printed circuit board 38′ transmits the data driving signal. One of the first and second electrodes 24 and 26 is applied with the scan driving signal, and the other is applied with the data driving signal.

When an image is displayed on the first pixel group, the corresponding second pixel of the light emission device 10 emits light with a gray level, which may be predetermined, by synchronizing with the first pixel group. The number of pixels of the light emission device in each row and each column may range from 2 to 99. In one embodiment, if the number of the pixels in each row and each column is greater than 99, the driving of the light emission device 10 becomes complicated, thereby increasing the manufacturing cost of the driving circuit.

As described above, the light emission device 10 independently controls a light emission intensity of each pixel and thus provides a proper intensity of light to the corresponding pixels of the display panel 40. As a result, the display device 100 of the present exemplary embodiment can enhance the dynamic contrast of the screen, thereby improving the display quality.

In view of the foregoing and according to a light emission device of an exemplary embodiment of the present invention, since the anode terminal of the light emission device is provided through (or drawn out though) a side member of the light emission device, damage to a substrate of the light emission device can be reduced (or prevented) and a dead space (e.g., an inactive region) of the light emission device can be reduced. In addition, a process for forming a structure on the substrate can be more easily performed.

According to a display device using the light emission device as a light source, since the screen contrast and screen dynamic contrast are enhanced, the display device quality thereof can be improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emission device comprising:
first and second substrates opposing each other;
a side member located between periphery regions of the first and second substrates to define a vacuum chamber with the first and second substrates;
an electron emission unit disposed on the first substrate; and
a light emission unit disposed on the second substrate and adapted to emit light using electrons emitted from the electron emission unit,
wherein the light emission unit includes a phosphor layer and an anode electrode disposed on a surface of the phosphor layer, and
wherein the anode electrode is applied with a voltage through an anode terminal penetrating through the side member.

2. The device of claim 1, wherein the side member has a through hole through which the anode terminal penetrates, and wherein the anode terminal includes a lead portion inserted and fixed in the through hole and a wire portion extending from the lead portion and contacting the anode electrode.

3. The device of claim 2, wherein the lead portion is arranged to be substantially in parallel with the first and second substrates, and wherein the wire portion is bent toward the anode electrode by an angle.

4. The device of claim 2, wherein a distal end of the wire portion contacting the anode electrode is rounded toward the first substrate.

5. The device of claim 2, wherein a distal end of the wire portion contacting the anode electrodes comprises means for protecting the anode electrode from a contact damage.

6. The device of claim 2, wherein the wire portion comprises a material having an elastic property.

7. The device of claim 6, wherein the elastic property of wire portion is adapted to allow the wire portion to be deformed while passing through the through hole and to be restored to its initial shape to contact the anode electrode.

8. The device of claim 1, wherein a sealing member is interposed between the side member and the anode terminal.

9. The device of claim 1, wherein a distance between the first and second substrates is in a range from about 5 mm to about 20 mm.

10. The device of claim 1, wherein the electron emission unit comprises:
a first electrode extending in a first direction;
a second electrode extending in a second direction crossing the first direction; and
an electron emission region electrically connected to one of the first electrode or the second electrode.

11. A display device comprising:
a display panel adapted to display an image; and
a light emission device configured with the display panel to emit light toward the display panel,
wherein the light emission device comprises:
first and second substrates opposing each other;
a side member located between periphery regions of the first and second substrates to define a vacuum chamber with the first and second substrates;
an electron emission unit disposed on the first substrate; and
a light emission unit disposed on the second substrate and including a phosphor layer and an anode electrode disposed on a surface of the phosphor layer, and
wherein the anode electrode is applied with a voltage through an anode terminal penetrating through the side member.

12. The device of claim 11, wherein the side member has a through hole through which the anode terminal penetrates, and wherein the anode terminal includes a lead portion inserted and fixed in the through hole and a wire portion extending from the lead portion and contacting the anode electrode.

13. The device of claim 12, wherein a sealing member is interposed between the side member and the anode terminal.

14. The device of claim 11, wherein the display panel is a liquid crystal panel.

15. The device of claim 11, wherein the display panel comprises first pixels and the light emission device comprises second pixels, wherein the second pixels are less in number than the first pixels, and wherein intensities of light emitted from the second pixels are independently controlled.

16. The device of claim 11, wherein the electron emission unit comprises:
a first electrode extending in a first direction;
a second electrode extending in a second direction crossing the first direction; and
an electron emission region electrically connected to one of the first electrode or the second electrode.

17. A display device comprising:
a display panel adapted to display an image with an external light;
a first substrate;
a second substrate disposed between the first substrate and the display panel;
a side member located between periphery regions of the first and second substrates to define a vacuum chamber with the first and second substrates;
an electron emission unit disposed on the first substrate; and
a light emission unit disposed on the second substrate and adapted to emit the external light using electrons emitted from the electron emission unit,
wherein the light emission unit includes a phosphor layer and an anode electrode disposed on a surface of the phosphor layer, and
wherein the anode electrode is applied with a voltage through an anode terminal penetrating through the side member.
